(19) United States
(12) Patent Application Publication
(10) Pub. No.: US 2026/0220327 A1
(43) Pub. Date: Jul. 30, 2026

(54) VIRTUAL FLOW RATE COMPUTING APPARATUS, VIRTUAL FLOW RATE COMPUTING METHOD, AND VIRTUAL FLOW RATE COMPUTING PROGRAM

(71) Applicant: Yokogawa Electric Corporation, Tokyo (JP)

(72) Inventors: Ikuhiko ISHIKAWA, Tokyo (JP); Kazutoshi OKAMOTO, Tokyo (JP); Soh KIMURA, Tokyo (JP); Moe GOTO, Tokyo (JP); Yuudai SUZUKI, Tokyo (JP); Yuichi HAYASHI, Tokyo (JP)

(21) Appl. No.: 19/146,907

(22) PCT Filed: Jan. 24, 2024
(86) PCT No.: PCT/JP2024/002029

§ 371 Date: Jul. 9, 2025

(30) Foreign Application Priority Data
Jan. 30, 2023 (JP) 2023-012036

(51) Int. Cl. G06F 30/20; G06F 113/08

(52) U.S. Cl. CPC G06F 30/20; G06F 2113/08

(57) ABSTRACT

Provided is a virtual flow rate computing apparatus including: an environment information storage unit which stores environment information indicating environment of a real space in which a flow rate sensor is instrumented; a physical property information storage unit which stores physical property information indicating physical properties of fluid to be measured; a simulation unit which executes a simulation related to measurement of the fluid in a virtual space, which reproduces the real space, by using the environment information and the physical property information; and a computing unit which computes a virtual flow rate, which is an estimate of an actual flow rate to be actually measured by the flow rate sensor, on the basis of a result of the simulation.

The contents of the following patent application(s) are incorporated herein by reference: NO. 2023-012036 filed in JP on Jan. 30, 2023

### TECHNICAL FIELD

The present invention relates to a virtual flow rate computing apparatus, a virtual flow rate computing method, and a virtual flow rate computing program.

### BACKGROUND ART

Patent Document 1 discloses “To provide a flow meter design support system which can improve accuracy in measurement of a differential pressure flow meter and can reduce, at a design stage, risk of non-negligible error of an indicated flow meter value caused at an actual machine.”.

### RELATED ART DOCUMENTS

### Patent Documents

Patent Document 1: Japanese Patent Application Publication No. 2020-144662
Patent Document 2: Japanese Patent Application Publication No. 2019-194424
Patent Document 3: Japanese Patent Application Publication No. 2012-132797
Patent Document 4: Japanese Patent Application Publication No. 2009-014726

### GENERAL DISCLOSURE

In a first aspect of the present invention, a virtual flow rate computing apparatus is provided. The virtual flow rate computing apparatus includes: an environment information storage unit which stores environment information indicating environment of a real space in which a flow rate sensor is instrumented; a physical property information storage unit which stores physical property information indicating physical properties of fluid to be measured; a simulation unit which executes a simulation related to measurement of the fluid in a virtual space, which reproduces the real space, by using the environment information and the physical property information; and a computing unit which computes a virtual flow rate, which is an estimate of an actual flow rate to be actually measured by the flow rate sensor, on the basis of a result of the simulation. The simulation unit may simulate at least one of a flow velocity at the portion of the flow rate sensor or a flow velocity distribution in the cross section of the flow rate sensor.

The virtual flow rate computing apparatus may further include a diagnosis unit which diagnoses the flow rate sensor on the basis of the actual flow rate and the virtual flow rate.

In any of the virtual flow rate computing apparatuses, the diagnosis unit may issue an alert when a difference between the actual flow rate and the virtual flow rate does not satisfy a predetermined criterion. The diagnosis unit may issue the alert when the difference between the actual flow rate and the virtual flow rate is equal to or larger than a threshold.

In any of the virtual flow rate computing apparatuses, the computing unit may decide processing for computing the virtual flow rate, on the basis of the actual flow rate and the virtual flow rate in a period in which an operation of the flow rate sensor is regarded as normal.

Any of the virtual flow rate computing apparatuses may further include a simulation result storage unit which stores a result of the simulation, and the computing unit may reuse at least a part of the stored result.

Any of the virtual flow rate computing apparatuses may further include a tendency identification unit which identifies a tendency of the virtual flow rate in a case where at least one variable of the environment information or the physical property information is varied.

Any of the virtual flow rate computing apparatuses may further include a notification unit which notifies a sensor module including the flow rate sensor of information regarding the tendency.

Any of the virtual flow rate computing apparatuses may further include a recommendation unit which decides the flow rate sensor to be recommended from among a plurality of flow rate sensors, on the basis of the tendency for each of the flow rate sensors. The recommendation unit may decide, as the flow rate sensor to be recommended, a flow rate sensor, which has the smallest variation in virtual flow rate with respect to one or more selected variables, among the plurality of flow rate sensors.

In any of the virtual flow rate computing apparatuses, the simulation unit may simulate at least one of stress, fluid, an electromagnetic field, or an ultrasonic wave in the virtual space.

In any of the virtual flow rate computing apparatuses, the flow rate sensor may be at least one of a Coriolis flow meter, an ultrasonic flow meter, an electromagnetic flow meter, or a vortex flow meter.

Any of the virtual flow rate computing apparatuses may be provided by a cloud server.

In a second aspect of the present invention, a virtual flow rate computing method is provided. The virtual flow rate computing method performed by a computer, comprising: storing environment information indicating environment of a real space in which a flow rate sensor is instrumented; storing physical property information indicating physical properties of fluid to be measured; executing a simulation related to measurement of the fluid in a virtual space, which reproduces the real space, by using the environment information and the physical property information; and computing a virtual flow rate, which is an estimate of an actual flow rate to be actually measured by the flow rate sensor, on the basis of a result of the simulation.

In a third aspect of the present invention, a virtual flow rate computing program is provided. The virtual flow rate computing program that, when executed by a computer, causes the computer to function as: an environment information storage unit which stores environment information indicating environment of a real space in which a flow rate sensor is instrumented; a physical property information storage unit which stores physical property information indicating physical properties of fluid to be measured; a simulation unit which executes a simulation related to measurement of the fluid in a virtual space, which reproduces the real space, by using the environment information and the physical property information; and a computing unit which computes a virtual flow rate, which is an estimate of an actual flow rate to be actually measured by the flow rate sensor, on the basis of a result of the simulation.

The summary clause does not necessarily describe all necessary features of the embodiments of the present invention. The present invention may also be a sub-combination of the features described above.

### BRIEF DESCRIPTION OF DRAWINGS

FIG. 1 illustrates an example of a block diagram of a virtual flow rate computing apparatus 100 according to the present embodiment together with a sensor module 10.

FIG. 2 illustrates an example of a flow diagram of a virtual flow rate computing method executed by the virtual flow rate computing apparatus 100 according to the present embodiment.

FIG. 3 illustrates an example of a block diagram of the virtual flow rate computing apparatus 100 functioning as a virtual Coriolis flow meter.

FIG. 4 illustrates an example of a block diagram of the virtual flow rate computing apparatus 100 functioning as a virtual ultrasonic flow meter.

FIG. 5 illustrates an example of a block diagram of the virtual flow rate computing apparatus 100 functioning as a virtual electromagnetic flow meter.

FIG. 6 illustrates an example of a block diagram of the virtual flow rate computing apparatus 100 functioning as a virtual vortex flow meter.

FIG. 7 illustrates an example of a block diagram of the virtual flow rate computing apparatus 100 according to a first modification together with the sensor module 10.

FIG. 8 illustrates an example of a block diagram of the virtual flow rate computing apparatus 100 according to a second modification together with the sensor module 10.

FIG. 9 illustrates an example of a computer 9900 in which a plurality of aspects of the present invention may be embodied in whole or in part.

### DESCRIPTION OF EMBODIMENTS

Hereinafter, the present invention will be described through embodiments of the invention, but the following embodiments do not limit the invention according to claims. In addition, not all of the combinations of features described in the embodiments are essential to the solution of the invention.

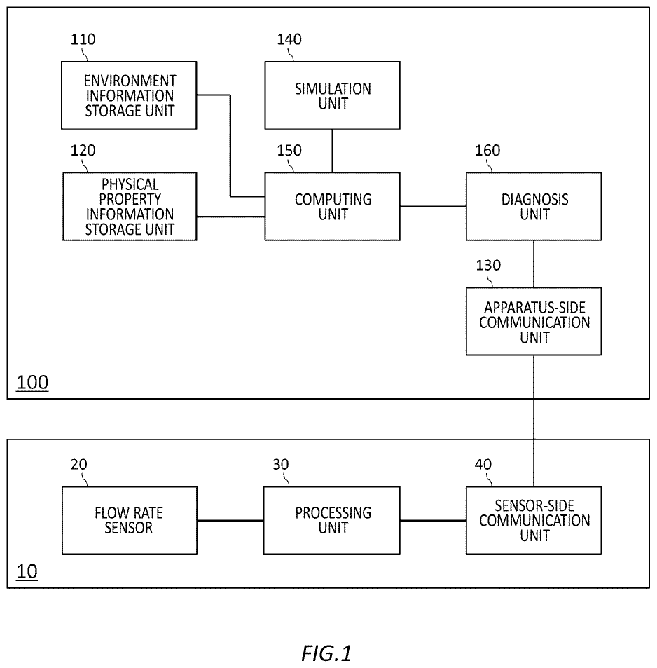

FIG. 1 illustrates an example of a block diagram of a virtual flow rate computing apparatus 100 according to the present embodiment together with a sensor module 10. Note that, these blocks are functional blocks that are each functionally divided, and may not be necessarily required to be matched with actual apparatus configurations. In other words, in the present figure, a unit shown as one block does not necessarily need to be configured by one device. In addition, in the present figure, units shown as separate blocks do not necessarily need to be configured by separate devices. The same applies to subsequent block diagrams.

The sensor module 10 is provided at various places of equipment, measures a physical quantity to be measured, and transmits measurement data to another apparatus. Such equipment may be, for example, an apparatus(es) for producing a product from raw materials. As an example, the equipment may be a plant. Examples of the plant may include a plant for managing and controlling wells such as a gas field and an oil field and surroundings thereof, a plant for managing and controlling hydroelectric, thermo electric and nuclear power generations and the like, a plant for managing and controlling environmental power generation such as solar power and wind power, a plant for managing and controlling water and sewerage, a dam, and the like, etc., in addition to chemical and bio industrial plants and the like. The sensor module 10 includes a flow rate sensor 20, a processing unit 30, and a sensor-side communication unit 40.

The flow rate sensor 20 is a measurement instrument which is instrumented in a real space (for example, a pipe of a plant, and the like) and measures an amount of fluid to be measured (liquid, gas, vapor, particulate matter, or a multi-phase state thereof) flowing through a pipeline per unit time. Examples of such a flow rate sensor 20 include various flow meters having different sensing principles according to various conditions such as a purpose of measurement, a measurement location, a type of fluid, or a state of the fluid. As an example, the flow rate sensor 20 may be at least one of a Coriolis flow meter, an ultrasonic flow meter, an electromagnetic flow meter, or a vortex flow meter.

The Coriolis flow meter is a flow meter using the Coriolis force that is a physical phenomenon. When fluid passes through a flow tube operating at a resonance frequency, the flow tube is twisted by inertia, and a phase change occurs in detection signals of vibration detection sensors attached to an inflow side and an outflow side of the flow tube. In the Coriolis flow meter, for example, such a phase change is detected and multiplied by a coefficient to output a flow rate.

The ultrasonic flow meter is a flow meter using a propagation time difference of ultrasonic waves. When ultrasonic waves are alternately transmitted and received diagonally across fluid in a pipeline, the ultrasonic waves travel slowly against the flow of the fluid and travel fast on the flow. In the ultrasonic flow meter, for example, a flow velocity is calculated by using such a difference between the propagation times of two ultrasonic waves, corrected with a flow rate correction coefficient into an average flow velocity at a surface, and then multiplied by the cross-sectional area of the pipeline, so as to output a flow rate.

The electromagnetic flow meter is a flow meter using Faraday's electromagnetic induction. When a magnetic field is generated by an electromagnet and a conductive fluid passes through the magnetic field, an electromotive force proportional to a flow velocity is generated in a direction perpendicular to both the direction of the magnetic field and the direction of the flow of the fluid. In the electromagnetic flow meter, for example, the magnitude of such an electromotive force is detected and multiplied by the cross-sectional area of the pipeline, so as to output a flow rate.

The vortex flow meter is a flow meter using a Karman vortex. When there is a columnar obstacle (vortex generator) in a flowing fluid, the Karman vortex is generated on the downstream side of the fluid. At this time, the flow velocity of the fluid and the vortex frequency of the Karman vortex are in a proportional relationship. In the vortex flow meter, for example, the flow velocity is calculated by using such a vortex frequency of the Karman vortex, and multiplied by the cross-sectional area of the pipeline, so as to output a flow rate.

The flow rate sensor 20 may be, for example, at least one of the Coriolis flow meter, the ultrasonic flow meter, the electromagnetic flow meter, or the vortex flow meter as above. Note that the sensor module 10 may further include another sensor (not illustrated) capable of measuring a physical quantity different from that of the flow rate sensor 20. For example, the sensor module 10 may further include other sensors such as a pressure gauge, a thermometer, a viscometer, a pH meter, a conductivity meter, or a slurry concentration meter.

The processing unit 30 performs signal processing on output signals from the flow rate sensor 20 and other sensors. The processing unit 30 may supply measurement data obtained by performing signal processing on the output signals from the sensors to the sensor-side communication unit 40. Such measurement data may be data indicating at least the actual flow rate actually measured by the flow rate sensor 20.

The sensor-side communication unit 40 includes a communication stack (including a data link layer and an application layer) and a communication driver (including a physical layer) for communicating with the virtual flow rate computing apparatus 100 in accordance with a communication protocol. The sensor-side communication unit 40 may transmit the measurement data supplied from the processing unit 30 to the virtual flow rate computing apparatus 100 via a network.

In general, the flow rate sensor 20 is calibrated under reference operation conditions in equipment traceable to national standards. As an example, the reference operation conditions are condition of fluid=water, fluid temperature=normal temperature+a, ambient temperature=normal temperature+a, and upstream/downstream straight pipe length=sufficient length. When such a flow rate sensor 20 is instrumented in the real space, use conditions such as a fluid type, a fluid temperature, an ambient temperature, or an upstream/downstream straight pipe length are different from the reference operation conditions at the time of calibration, and thus a difference from a calibration value occurs.

Of course, a supplier of the flow rate sensor 20 performs design to reduce the influence of use environment and fluid physical properties at a certain level on the assumption of such a difference in use conditions. However, when there is a change in a meter due to long-term use or a change in actual flow equipment, it is necessary to estimate the actual flow rate on the basis of the output variation and the internal status information of the flow rate sensor 20 instrumented in the real space. In addition, for the soundness of the flow rate sensor 20, it is necessary to finally perform recalibration with the equipment traceable to national standards.

In this regard, the virtual flow rate computing apparatus 100 according to the present embodiment executes a simulation related to the measurement of fluid in a virtual space assuming the use conditions such as the use environment of the flow rate sensor 20 instrumented in the real space or the fluid physical properties, and computes a virtual flow rate, which is an estimate of the above-described actual flow rate, on the basis of the simulation result. The virtual flow rate computing apparatus 100 according to the present embodiment includes an environment information storage unit 110, a physical property information storage unit 120, an apparatus-side communication unit 130, a simulation unit 140, a computing unit 150, and a diagnosis unit 160.

The environment information storage unit 110 stores environment information indicating the environment of the real space in which the flow rate sensor 20 is instrumented. For example, the environment information storage unit 110 may be a database, and may store the environment information acquired via a user input, various memory devices, a network, or the like so as to be accessible from the computing unit 150.

The physical property information storage unit 120 stores physical property information indicating the physical properties of fluid to be measured. For example, the physical property information storage unit 120 may be a database, and may store the physical property information acquired via a user input, various memory devices, a network, or the like so as to be accessible from the computing unit 150.

The apparatus-side communication unit 130 includes a communication stack and a communication driver for communicating with the sensor module 10 in accordance with a communication protocol. For example, the apparatus-side communication unit 130 may communicate with the sensor module 10 via a network and acquire measurement data from the sensor module 10. As described above, such measurement data may be data indicating at least the actual flow rate actually measured by the flow rate sensor 20. The apparatus-side communication unit 130 may supply the acquired measurement data to the diagnosis unit 160.

The simulation unit 140 executes a simulation related to the measurement of fluid in a virtual space, which reproduces the real space, by using the environment information and the physical property information. For example, the simulation unit 140 may execute the simulation related to measurement of fluid in the virtual space by using the environment information stored in the environment information storage unit 110 and the physical property information stored in the physical property information storage unit 120 according to an instruction from the computing unit 150. The simulation unit 140 may supply the simulation result to the computing unit 150.

The computing unit 150 computes a virtual flow rate, which is an estimate of an actual flow rate to be actually measured by the flow rate sensor 20, on the basis of the simulation result. For example, the computing unit 150 may acquire the simulation result from the simulation unit 140 and compute the virtual flow rate, which is the estimate of the actual flow rate to be actually measured by the flow rate sensor 20, on the basis of the simulation result. The computing unit 150 may notify the diagnosis unit 160 of the computed virtual flow rate.

The diagnosis unit 160 diagnoses the flow rate sensor 20 on the basis of the actual flow rate and the virtual flow rate. For example, the diagnosis unit 160 may compare the actual flow rate indicated by the measurement data supplied from the apparatus-side communication unit 130 with the virtual flow rate notified from the computing unit 150 to diagnose the flow rate sensor 20.

The virtual flow rate computing apparatus 100 including such a functional unit may be a computer such as a personal computer (PC), a tablet computer, a smartphone, a workstation, a server computer, or a general-purpose computer, or may be a computer system in which a plurality of computers are connected. Such a computer system is also a computer in a broad sense. In addition, the virtual flow rate computing apparatus 100 may be implemented by one or more virtual computer environments executable in a computer. Alternatively, the virtual flow rate computing apparatus 100 may be a dedicated computer designed for computing a virtual flow rate, or may be dedicated hardware realized by a dedicated circuit. In addition, when connection to the Internet is possible, the virtual flow rate computing apparatus 100 may be realized by cloud computing. In particular, the virtual flow rate computing apparatus 100 is preferably provided by a cloud server from the viewpoint of processing capability and memory capacity.

In addition, such a computer may include a memory which stores a virtual flow rate computing program and a processor which executes the virtual flow rate computing program, and a function as the virtual flow rate computing apparatus 100 may be implemented by the processor executing the virtual flow rate computing program. That is, there may be provided a virtual flow rate computing program that, when executed by a computer, causes the computer to function as: the environment information storage unit 110 which stores environment information indicating environment of a real space in which the flow rate sensor 20 is instrumented; the physical property information storage unit 120 which stores physical property information indicating physical properties of fluid to be measured; a simulation unit 140 which executes a simulation related to measurement of the fluid in a virtual space, which reproduces the real space, by using the environment information and the physical property information; and the computing unit 150 which computes a virtual flow rate, which is an estimate of an actual flow rate to be actually measured by the flow rate sensor 20, on the basis of a result of the simulation.

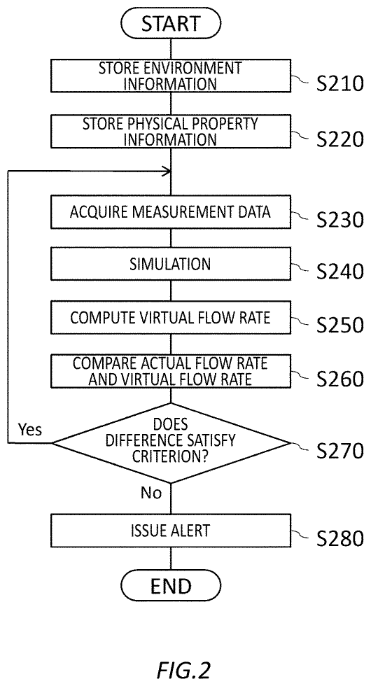

FIG. 2 illustrates an example of a flow diagram of a virtual flow rate computing method executed by the virtual flow rate computing apparatus 100 according to the present embodiment. Each step in the virtual flow rate computing method may be executed by a computer as an operation subject. However, in each step, it is sufficient that the computer is the operation subject as a whole, and a case may be included in which a part other than the computer executes a part which is not a main part.

In step S210, the computer stores the environment information. For example, the environment information storage unit 110 may the store environment information, which indicates the environment of the real space in which the flow rate sensor 20 is instrumented, so as to be accessible from the computing unit 150. At this time, as an example, the environment information storage unit 110 may store, as the environment information, information of a pipe attached to the outside of the flow rate sensor 20 (the straight pipe length, the state of elbow on an upstream/downstream side, or the like), information of an attachment gasket, information of fluid (a liquid type, a concentration, the presence or absence of a mixed phase, an assumed temperature, an assumed pressure, or the like), information of a peripheral device, or the like. Note that a part of such environment information, for example, the pipe information, or the like may be extracted from computer aided design (CAD) data, aerial photographing data, or the like.

Here, when the use environment varies over time, the environment information storage unit 110 may store, as the environment information, measurement data by another sensor such as a pressure gauge, a thermometer, a viscometer, a pH meter, a conductivity meter, or a slurry concentration meter, which is instrumented in the real space similarly to the flow rate sensor 20. In addition, the environment information storage unit 110 may store, as the environment information, the measurement data by the flow rate sensor 20, that is, the actual flow rate itself actually measured by the flow rate sensor 20. In such a case, the environment information storage unit 110 may store the measurement data in time series on the assumption that the data changes over time.

In step S220, the computer stores the physical property information. For example, the physical property information storage unit 120 may store the physical property information, which indicates the physical properties of fluid to be measured, so as to be accessible from the computing unit 150. At this time, as an example, the physical property information storage unit 120 may store, as the physical property information, information, such as density, viscosity, conductivity, electrical resistivity, dielectric constant, or acoustic characteristics, including the temperature and pressure characteristics of the fluid to be measured. In addition, in the above description, a case where the physical property information storage unit 120 stores only the physical property information indicating the physical property of the fluid to be measured has been described as an example, but the present invention is not limited thereto. The physical property information storage unit 120 may also store the physical property information indicating the physical properties of various substances, which are required for a simulation, other than the fluid to be measured. At this time, the physical property information storage unit 120 may store, as the physical property information, various types of information (for example, metal resistivity and temperature characteristics of mechanical physical properties) described in so-called chronological scientific tables or various basic physical property databases.

In step S230, the computer acquires the measurement data. For example, the apparatus-side communication unit 130 may acquire the measurement data from the sensor module 10 via the network. As described above, such measurement data may be data indicating at least the actual flow rate actually measured by the flow rate sensor 20.

At this time, the environment information storage unit 110 may update the environment information stored in step S210 by adding the acquired measurement data (the measurement data by the flow rate sensor 20 or the measurement data by another sensor) in time series.

In step S240, the computer executes a simulation. For example, the computing unit 150 may access the environment information storage unit 110 to acquire the environment information required for the simulation. In addition, the computing unit 150 may access the physical property information storage unit 120 to acquire the physical property information required for the simulation. Note that as described above, such physical property information may include information indicating the physical properties of fluid to be measured, or may include information indicating the physical properties of substances other than the fluid to be measured. Then, the computing unit 150 may supply these pieces of information to the simulation unit 140 and instruct the execution of the simulation. In response to this, the simulation unit 140 may execute the simulation related to the measurement of fluid in a virtual space which reproduces the real space, for example, on a digital twin, by using the environment information and the physical property information.

As an example, the simulation unit 140 may execute the simulation by using a known numerical analysis method such as a finite element method (FEM) or a finite difference method (FDM). At this time, the simulation unit 140 may simulate at least one of stress, fluid, an electromagnetic field, or an ultrasonic wave in the virtual space.

For example, in the stress simulation, the simulation unit 140 may simulate a vibration state of being applied to the flow rate sensor 20 through a pipe from a vibration source such as a pump. In addition, the simulation unit 140 may simulate a fluid pressure to be applied to the flow rate sensor 20 on the basis of information of a pressure gauge, a level gauge, or the like. In addition, the simulation unit 140 may simulate the distribution of stress to a pipe due to bolt fastening, stamping, or the like between pipes.

In addition, for example, in the fluid simulation, the simulation unit 140 may input basic information such as a pump lift, fluid, and a pressure loss from the entire piping system to simulate the flow velocity at the portion of the flow meter to be used in the real space. In this case, by executing the fluid simulation in a full model, it is possible to directly compare the actual flow rate with the virtual flow rate. The advantage here is that it is possible to know a flow velocity distribution in a flow meter cross section which changes depending on the flow velocity and the fluid viscosity. The Coriolis flow meter, the ultrasonic flow meter, the electromagnetic flow meter, and the vortex flow meter are easily affected by the flow velocity distribution, but it is possible to estimate whether the output thereof depends on the flow velocity distribution. On the other hand, when it is difficult to perform a fluid simulation, which assumes piping of the entire equipment such as a plant, in terms of performance of a computing apparatus, the simulation unit 140 may execute the simulation with some elements omitted. In this case, a deviation between the actual flow rate and the virtual flow rate may occur. Therefore, in such a case, the simulation unit 140 may set, as an initial value, a set point flow rate set by proportional integral differential (PID) control on a control system used in a plant or the like, or may set, as the initial value, an actual flow rate value in a period regarded as a normal operation. The simulation unit 140 can reduce a computing load by partially executing the fluid simulation, but in this case, a difference from the value of the virtual flow rate and the value of the actual flow rate regarded as a normal operation state is observed.

In addition, for example, in the electromagnetic field simulation, the simulation unit 140 may give, as initial values, applied current values of two coils provided in the flow rate sensor 20, and simulate a magnetic flux density distribution in the cross section of the pipeline.

In addition, for example, in an ultrasonic propagation simulation, the simulation unit 140 may simulate an ultrasonic propagation time, the attenuation of an ultrasonic signal, or the like from fluid physical properties, the parameter of a plant pipe, and an environmental temperature.

As described above, the simulation unit 140 may simulate at least one of stress, fluid, an electromagnetic field, or an ultrasonic wave, preferably a combination thereof, in the virtual space.

In step S250, the computer computes the virtual flow rate. For example, the computing unit 150 may compute the virtual flow rate, which is an estimate of the actual flow rate to be actually measured by the flow rate sensor 20, on the basis of the simulation result in step S240. In general, the flow velocity distribution and the fluid physical properties (the pressure, density, viscosity, or the like of fluid) change depending on pipe conditions, fluid conditions, or the like. However, the computing unit 150 computes the virtual flow rate on the basis of the simulation result using the environment information and the physical property information. Accordingly, the computing unit 150 can reflect actual use environment and the fluid physical properties in calculation, so as to compute the virtual flow rate which is a more accurate estimate of the actual flow rate. Specific computing of the virtual flow rate will be described later in detail for each sensing principle of the flow meter.

The computing unit 150 may decide processing for computing the virtual flow rate, on the basis of the actual flow rate and the virtual flow rate in a period in which the operation of the flow rate sensor 20 is regarded as normal. More specifically, when there is a difference between the virtual flow rate, which is computed in a period in which the operation is regarded as normal at the time of instrumentation of the flow rate sensor 20 into the real space, and the actual flow rate, the computing unit 150 may multiply the virtual flow rate computed as a correction value by a ratio corresponding to the difference and regard the result as the initial result of the virtual flow rate. Accordingly, for example, even when the flow rate sensor 20 includes an error over time, by aligning the computing result of the virtual flow rate with the actual flow rate in an initial stage not including the error over time, for example, immediately after the flow rate sensor 20 is attached to the real space, it is possible to calibrate a virtual flow meter with an initial value of a correct flow rate (a flow rate closer to the actual flow rate not including the error over time). In addition, by adding the computing condition of the virtual flow rate (for example, using the measurement data in the real space as the ambient temperature or setting the convergence value setting of the simulation to a smaller value), the computing unit 150 may bring the virtual flow rate close to the actual flow rate by repetitive calculation. In addition, when computing the virtual flow rate on the basis of the result of the fluid simulation, the computing unit 150 may compute the virtual flow rate on the basis of the result of the fluid simulation with the actual flow rate, and compute the virtual flow rate closer to the actual flow rate by repeating a procedure of computing the virtual flow rate by the fluid simulation using a value closer to the actual flow rate.

In step S260, the computer compares the actual flow rate with the virtual flow rate. For example, the diagnosis unit 160 may compare the actual flow rate indicated by the measurement data acquired in step S230 with the virtual flow rate computed in step S250.

In step S270, the computer determines whether the difference satisfies a criterion. For example, as a result of the comparison in step S260, the diagnosis unit 160 may determine whether the difference between the actual flow rate and the virtual flow rate satisfies a predetermined criterion. When it is determined that the difference satisfies the criterion (Yes) (for example, the difference is less than a threshold), the virtual flow rate computing apparatus 100 may return the processing to step S230 and continue the flow. On the other hand, when it is determined that the difference does not satisfy the criterion (No) (for example, the difference is greater than or equal to the threshold), the virtual flow rate computing apparatus 100 may advance the processing to step S280.

In step S280, the computer issues an alert. For example, the diagnosis unit 160 may output a message that the difference does not satisfy the criterion to be displayed on the monitor, may output the message as a speech, may output the message as print, or may transmit a signal. For example, in this manner, the diagnosis unit 160 may issue the alert when the difference between the actual flow rate and the virtual flow rate does not satisfy the predetermined criterion. Accordingly, the diagnosis unit 160 can diagnose the flow rate sensor 20 on the basis of the actual flow rate and the virtual flow rate.

Then, the virtual flow rate computing apparatus 100 ends this flow. Note that the virtual flow rate computing apparatus 100 can dynamically perform these computing and diagnose. For example, the virtual flow rate computing apparatus 100 may continuously compute the virtual flow rate and diagnose the flow rate sensor 20 at a cycle multiple times the measurement cycle of the actual flow rate. In addition, the virtual flow rate computing apparatus 100 may compute the virtual flow rate and diagnose the flow rate sensor 20 at a timing (for example, every hour, every day, a timing depending on an event such as start of operation, or the like) designated by a user. In addition, the virtual flow rate computing apparatus 100 may compute the virtual flow rate and diagnose the flow rate sensor 20 at a timing when the variation of the actual flow rate becomes a value (for example, 5% of the measurement span) designated by the user or the system, a timing when the condition input to the environment information or the physical property information is changed, or a timing when the change exceeds the value (for example, 5%) designated by the user or the system.

As described using this flow, there may be provided a virtual flow rate computing method performed by a computer, including: storing environment information indicating environment of a real space in which the flow rate sensor 20 is instrumented; storing physical property information indicating physical properties of fluid to be measured; executing a simulation related to measurement of the fluid in a virtual space, which reproduces the real space, by using the environment information and the physical property information; and computing a virtual flow rate, which is an estimate of an actual flow rate to be actually measured by the flow rate sensor 20, on the basis of a result of the simulation. Thus, specific computing of the virtual flow rate will be described in detail for each type of flow meter.

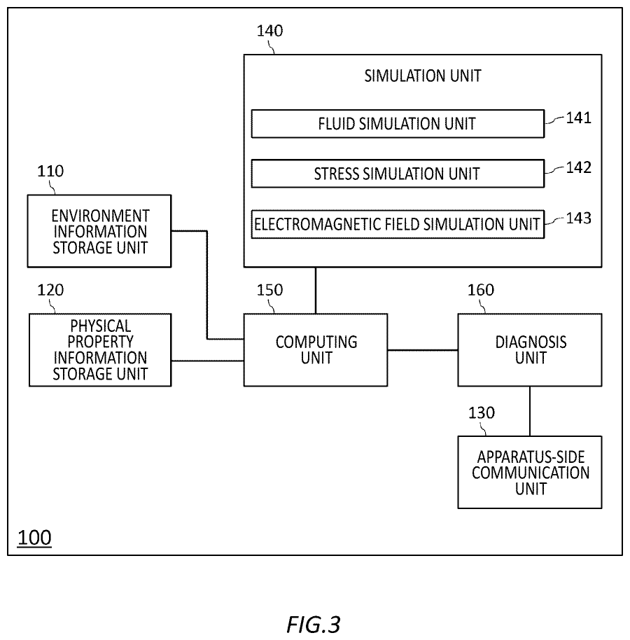

FIG. 3 illustrates an example of a block diagram of the virtual flow rate computing apparatus 100 functioning as a virtual Coriolis flow meter. The virtual flow rate computing apparatus 100 may function as the virtual Coriolis flow meter. When functioning as the virtual Coriolis flow meter, the simulation unit 140 may include, for example, a fluid simulation unit 141, a stress simulation unit 142, and an electromagnetic field simulation unit 143. Then, the virtual flow rate computing apparatus 100 may estimate the output value of the Coriolis flow meter to be used in the real space by using, for example, the fluid simulation unit 141, the stress simulation unit 142, and the electromagnetic field simulation unit 143.

More specifically, when a coefficient which is a function of a structural feature amount such as a flow tube shape and a position of a vibration detection sensor is denoted by SK, and a phase time difference calculated from a phase difference between vibrations generated on the upstream side and the downstream side of the flow tube is denoted by t, the computing unit 150 may compute a virtual flow rate Q by the following equation. That is, the computing unit 150 may compute the virtual flow rate Q by the product of the coefficient SK and the phase time difference τ. Here, the phase time difference t is obtained by dividing a phase difference φ generated in the vibration detection sensor by an excitation frequency fr of an oscillator. Therefore, a virtual flow rate Q can also be expressed as a product of the coefficient SK and the phase difference ¢, divided by the excitation frequency fr.

$$Q = SK \cdot τ = SK \cdot \frac{ϕ}{fr} \qquad ( Expression 1 )$$

At this time, the simulation unit 140 may execute the stress simulation by using the stress simulation unit 142 in relation to the coefficient SK. As an example, the stress simulation unit 142 may output the flow tube shape of the virtual Coriolis flow meter by using, as inputs, a 3D model of the flow tube, the oscillator, and the vibration detection sensor under a normal temperature and a normal pressure and the temperature and pressure obtained from the meter in the real space. Furthermore, the stress simulation unit 142 may output the resonance frequency or the inertia moment of the flow tube necessary for calculating the coefficient SK, by using, as inputs, the same flow tube shape and the Young's modulus under the same conditions.

Then, the computing unit 150 may calculate the coefficient SK by calculating a feature amount such as a natural angular frequency from the result of the stress simulation in which the temperature and pressure applied to the flow tube and the exciting force of the oscillator which is the power of vibration of the flow tube are added as described above, and substituting the calculated feature amount into a function having, as a variable, the feature amount derived in advance.

In addition, in relation to the phase time difference t, the simulation unit 140 may execute a coupled simulation by using the fluid simulation unit 141, the stress simulation unit 142, and the electromagnetic field simulation unit 143. Then, the computing unit 150 may calculate the phase time difference t by calculating the phase difference φ generated in the vibration detection sensor from the result of the coupled simulation and dividing the phase difference ¢ by the excitation frequency fr of the oscillator.

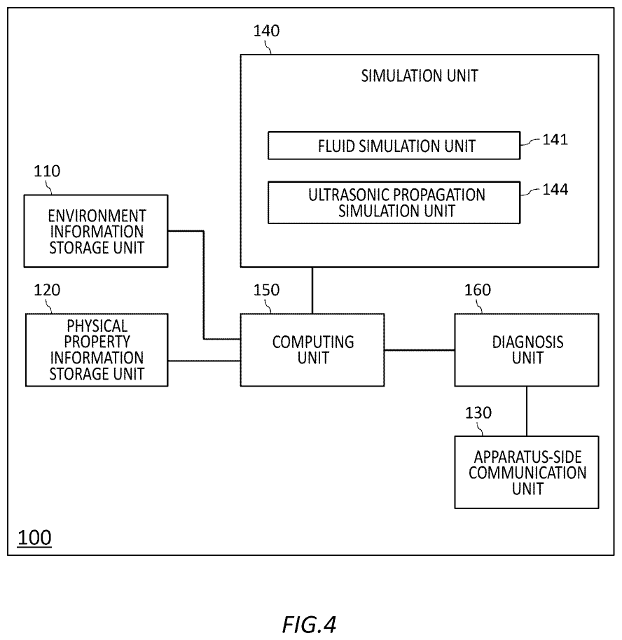

FIG. 4 illustrates an example of a block diagram of the virtual flow rate computing apparatus 100 functioning as a virtual ultrasonic flow meter. The virtual flow rate computing apparatus 100 may function as the virtual ultrasonic flow meter. When functioning as the virtual ultrasonic flow meter, the simulation unit 140 may include, for example, the fluid simulation unit 141 and an ultrasonic propagation simulation unit 144. Then, the virtual flow rate computing apparatus 100 may estimate the output value of the ultrasonic flow meter to be used in the real space by using, for example, the fluid simulation unit 141 and the ultrasonic propagation simulation unit 144.

More specifically, when an angle between a measurement pipe axis and an ultrasonic propagation axis is denoted by 0, a distance by which an ultrasonic wave propagates is denoted by L, a propagation time for which the ultrasonic wave propagates from the upstream side to the downstream side is denoted by t1, and a propagation time for which the ultrasonic wave propagates from the downstream side to the upstream side is denoted by t2, the computing unit 150 may calculate a flow velocity v by the following equation. That is, the computing unit 150 may calculate the flow velocity v by using a function of an inverse difference (frequency difference) of the propagation time.

$$v = \frac{L}{2 cos θ} ( \frac{1}{{t}_{1}} - \frac{1}{{t}_{2}} ) \qquad ( Expression 2 )$$

Then, when a flow rate correction coefficient is denoted by k and the cross-sectional area of the pipeline is denoted by A, the computing unit 150 may compute the virtual flow rate Q by the following equation. That is, the computing unit 150 may compute the virtual flow rate by correcting the flow velocity v with the flow rate correction coefficient k into an average flow velocity at a cross section through which the fluid flows, and then multiplying the average flow velocity by the cross-sectional area A of the pipeline.

$$Q = \frac{Av}{k} \qquad ( Expression 3 )$$

At this time, the simulation unit 140 may execute the fluid simulation by using the fluid simulation unit 141 in relation to the propagation times t1 and t2. As an example, the fluid simulation unit 141 may calculate a three-dimensional flow velocity distribution in the measurement pipe in consideration of an upstream/downstream straight pipe length, an upstream/downstream flow elbow, the fluid viscosity, or the like. At this time, the actual flow rate (flow velocity) output value of the flow rate sensor 20 instrumented in the real space may be used as necessary.

In addition, the simulation unit 140 may execute the ultrasonic propagation simulation by using the ultrasonic propagation simulation unit 144. As an example, with respect to the ultrasonic wave emitted from a piezoelectric element, the ultrasonic propagation simulation unit 144 may calculate propagation times in a direction from the upstream to the downstream and in a direction from the downstream to the upstream at upstream and downstream sensor attachment positions when the flow rate is 0. Then, the ultrasonic propagation simulation unit 144 may simulate the propagation of the ultrasonic wave by calculating the propagation times in consideration of pipe parameters such as a pipe wall thickness and a scale, and a temperature (the environmental temperature and the fluid temperature).

Then, the computing unit 150 may calculate the propagation time t1 from the upstream side to the downstream side and the propagation time t2 from the downstream side to the upstream side by a coupled analysis using the three-dimensional flow velocity distribution in the measurement pipe and the propagation times based on the simulation result of the ultrasonic propagation. By the coupled analysis, the propagation times t1 and t2 can be calculated in which the propagation times calculated by the ultrasonic propagation simulation are combined with the three-dimensional flow velocity distribution calculated by the fluid simulation.

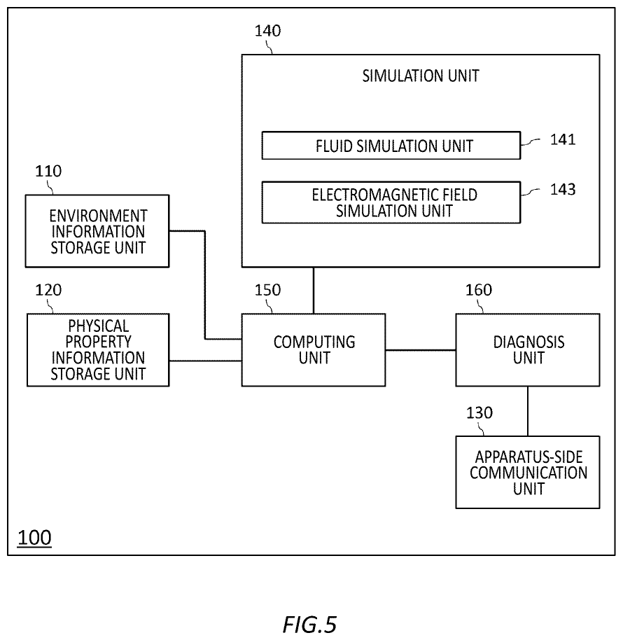

FIG. 5 illustrates an example of a block diagram of the virtual flow rate computing apparatus 100 functioning as a virtual electromagnetic flow meter. The virtual flow rate computing apparatus 100 may function as the virtual electromagnetic flow meter. When functioning as the virtual electromagnetic flow meter, the simulation unit 140 may include, for example, the fluid simulation unit 141 and an electromagnetic field simulation unit 143. Then, the virtual flow rate computing apparatus 100 may estimate the output value of the electromagnetic flow meter to be used in the real space by using, for example, the fluid simulation unit 141 and the electromagnetic field simulation unit 143.

More specifically, the computing unit 150 may compute an electromotive force e generated in an electrode by the following equation. That is, the computing unit 150 may calculate the electromotive force e by multiplying and integrating a weight function w, a magnetic flux density B, and a flow velocity v.

$$e = \int ( w \cdot B \cdot v ) ds \qquad ( Expression 4 )$$

Then, the computing unit 150 may compute the virtual flow rate Q by the following equation. That is, the computing unit 150 may compute the virtual flow rate Q by using the calculated electromotive force e, a pipe inner diameter D, and a constant K.

$$Q = ( \frac{π D}{4 KB} ) \cdot e \qquad ( Expression 5 )$$

Here, in relation to the magnetic flux density B, the simulation unit 140 may execute an electromagnetic field simulation by using the electromagnetic field simulation unit 143. As an example, the electromagnetic field simulation unit 143 may calculate the magnetic flux density distribution in the measurement pipe by inputting the dimensions of the coil and the magnetic material of the electromagnetic flow meter and the physical property values of the magnetic material. At this time, for the magnetic flux density, the actually measured magnetic flux density distribution in the measurement pipe may be stored as a database. When there is not design information, which is at least one of the dimensions of the coil and the magnetic material of a product of another company or the physical property values of the magnetic material, of the product or the like of another company, this method enables handling.

In addition, in relation to the flow velocity v, the simulation unit 140 may execute the fluid simulation by using the fluid simulation unit 141. As an example, the fluid simulation unit 141 may calculate a flow velocity distribution at the cross section of a measurement pipeline in consideration of the upstream/downstream straight pipe length, the upstream/downstream flow elbow, the fluid viscosity, or the like. At this time, the actual flow rate (flow velocity) output value of the flow rate sensor 20 instrumented in the real space may be used as necessary.

The weight function w is a function of an electric field (magnetic flux density×flow velocity) generated at each point in the measurement pipeline and a distance between electrodes, and for example, a weight function described in JIS B 7554 or a weight function based on an electrode shape or an arrangement position may be used.

Then, the computing unit 150 may calculate the electromotive force e generated in the electrode by multiplying the electric field (magnetic flux density B×flow velocity v) generated at each point in the measurement pipeline by the weight function w and integrating the result. At this time, since there is a case where material physical properties or the like have a certain constant width, the calculated electromotive force e may be multiplied by a certain coefficient.

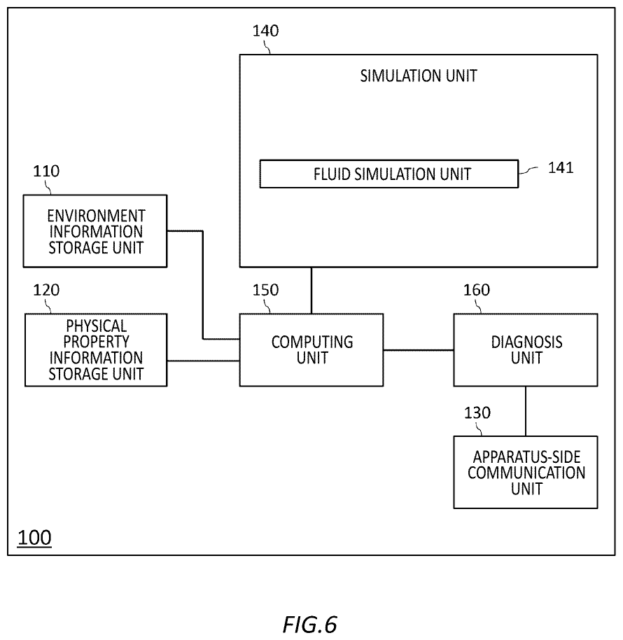

FIG. 6 illustrates an example of a block diagram of the virtual flow rate computing apparatus 100 functioning as a virtual vortex flow meter. The virtual flow rate computing apparatus 100 may function as the virtual vortex flow meter. When functioning as a virtual vortex flow meter, the simulation unit 140 may include, for example, the fluid simulation unit 141. Then, the virtual flow rate computing apparatus 100 may estimate the output value of the vortex flow meter to be used in the real space by using, for example, the fluid simulation unit 141.

More specifically, the computing unit 150 may compute the virtual flow rate Q by the following equation. That is, the computing unit 150 may compute the virtual flow rate Q by multiplying the vortex frequency f by the pipeline cross-sectional area A and a width d of the vortex generator and dividing the result by a stroke hull number St. Note that the stroke hull number St is a dimensionless number decided by the shape and dimension of the vortex generator.

$$Q = ( \frac{Ad}{St} ) \cdot f \qquad ( Expression 6 )$$

Here, in relation to the vortex frequency f, the simulation unit 140 may execute the fluid simulation by using the fluid simulation unit 141. As an example, the fluid simulation unit 141 may input the physical property values of fluid, the shape of a vortex rod, and the condition (a straight pipe length, a step, or the like) of a pipe to simulate the aspect of vortex generation in the measurement pipeline. At this time, the actual flow rate (flow velocity) output value of the flow rate sensor 20 instrumented in the real space may be used as necessary.

In addition, the simulation unit 140 may calculate a pressure distribution and a temperature distribution in the measurement pipeline by using the fluid simulation unit 141. Then, for example, particularly when the measurement fluid is gas, the computing unit 150 may correct the virtual flow rate Q with respect to the distribution of the calculated pressure and temperature in the measurement pipeline.

The virtual flow rate computing apparatus 100 according to the present embodiment can function as, for example, at least one of the virtual Coriolis flow meter, the virtual ultrasonic flow meter, the virtual electromagnetic flow meter, or the virtual vortex flow meter in this manner.

In the conventional technique, external environmental factors such as the flow of a flow meter unit and pipe vibration in the use environment of the user are not assumed, and the flow meter output is not simulated in real time. In addition, in the flow rate measurement, the influence of the flow velocity distribution in the measurement pipe varies depending on the use environment, and the fluid physical properties themselves also vary depending on the multi-phase state, which affect the measurement accuracy. However, it is extremely difficult to estimate the actual flow rate of the flow meter output in consideration of these.

On the other hand, the virtual flow rate computing apparatus 100 according to the present embodiment executes a simulation related to the measurement of fluid in a virtual space assuming the use conditions such as the use environment of the flow rate sensor 20 instrumented in the real space or the fluid physical properties, and computes a virtual flow rate on the basis of the simulation result. Accordingly, according to the virtual flow rate computing apparatus 100 according to the present embodiment, it is possible to estimate the actual flow rate actually measured by the flow rate sensor 20 with high accuracy in accordance with the use conditions such as the actual use environment of the user or the fluid physical properties. Therefore, according to the virtual flow rate computing apparatus 100 according to the present embodiment, it is possible to support the operation of the flow rate measurement of the flow rate sensor 20 which is instrumented in the real space and is affected by the use conditions, and eventually, it is possible to lead to the stable operation of an instrumentation system.

In addition, the virtual flow rate computing apparatus 100 according to the present embodiment may diagnose the flow rate sensor 20 on the basis of the actual flow rate and the virtual flow rate. At this time, the virtual flow rate computing apparatus 100 according to the present embodiment may issue an alert when the difference between the actual flow rate and the virtual flow rate does not satisfy the criterion. Accordingly, according to the virtual flow rate computing apparatus 100 according to the present embodiment, it is possible to diagnose whether the flow rate sensor 20 itself is correctly functioning or whether the flow rate sensor 20 is correctly instrumented, on the basis of whether the computed virtual flow rate is an intended value in light of the actual flow rate, and when an abnormality is suspected (there is a possibility that an unexpected matter has occurred in the flow rate sensor 20), it is possible to notify the user of the fact.

In addition, the virtual flow rate computing apparatus 100 according to the present embodiment may decide the processing in the computing unit 150 on the basis of the actual flow rate and the virtual flow rate in the period in which the operation of the flow rate sensor 20 is regarded as normal. Accordingly, according to the virtual flow rate computing apparatus 100 according to the present embodiment, it is possible to learn the algorithm of computing processing so that the computed virtual flow rate approaches the actual flow rate in the normal period.

In addition, the virtual flow rate computing apparatus 100 according to the present embodiment functions as at least one of the virtual Coriolis flow meter, the virtual ultrasonic flow meter, the virtual electromagnetic flow meter, or the virtual vortex flow meter on the basis of the result of at least one of the stress simulation, the fluid simulation, the electromagnetic field simulation, or the ultrasonic simulation executed in the virtual space, preferably, the coupled simulation including a combination thereof. Accordingly, according to the virtual flow rate computing apparatus 100 according to the present embodiment, the virtual flow rate is computed on the basis of various simulation results, and thus it is possible to compute the virtual flow rate with high accuracy in accordance with the sensing principle of the flow meter.

Here, in order to estimate the flow meter output in consideration of the influence of the use environment and the multi-phase state, a high-speed computing unit and a large-capacity memory are required, but it is extremely difficult to provide these inside the flow meter. On the other hand, the virtual flow rate computing apparatus 100 according to the present embodiment may be provided by a cloud server. Accordingly, according to the virtual flow rate computing apparatus 100 according to the present embodiment, it is possible to remove restrictions such as the processing capability, the memory capacity, and the power consumption of the processor mounted on the flow meter in the real space. Therefore, according to the virtual flow rate computing apparatus 100 according to the present embodiment, a flow rate output that incorporates various instrumentation conditions of the flow meter can be obtained by increasing the data amount and the degree of freedom of computing.

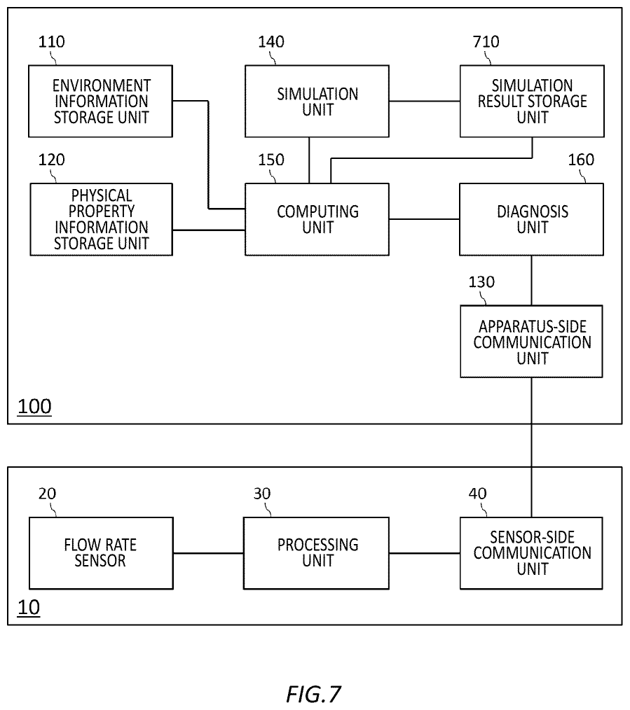

FIG. 7 illustrates an example of a block diagram of the virtual flow rate computing apparatus 100 according to a first modification together with the sensor module 10. In the above-described embodiment, a case where the virtual flow rate computing apparatus 100 executes simulation each time when computing the virtual flow rate has been described as an example. However, in the present modification, the virtual flow rate computing apparatus 100 reuses at least a part of the simulation result.

The virtual flow rate computing apparatus 100 according to the present modification further includes a simulation result storage unit 710. In the present modification, the simulation unit 140 adds the simulation result to the computing unit 150 and supplies the simulation result to the simulation result storage unit 710.

The simulation result storage unit 710 stores the simulation result. For example, the simulation result storage unit 710 may be a database, and may store the result simulated by the simulation unit 140 so as to be accessible from the computing unit 150.

The computing unit 150 may access the simulation result storage unit 710 to acquire the stored result. Then, the computing unit 150 may reuse at least a part of the stored result in computing the virtual flow rate.

The virtual flow rate computing apparatus 100 according to the present modification may store simulation results executed in the past and reuse at least a part of the simulation results. Accordingly, according to the virtual flow rate computing apparatus 100 according to the present modification, since the calculated result is stored once, it is not necessary to perform re-simulation under the condition that has already been executed, and thus, it is possible to reduce the load of the calculation and to perform analysis in consideration of a plurality of conditions by a learning computing module (AI analysis). In addition, according to the virtual flow rate computing apparatus 100 according to the present modification, it is not always necessary to perform a full model simulation including the stress, fluid, electromagnetic field, and ultrasonic propagation simulations in real time each time, and it is possible to greatly reduce the amount of computing to be executed in real time by storing simulation results under various conditions in advance and obtaining simulation results recursively from the stored results.

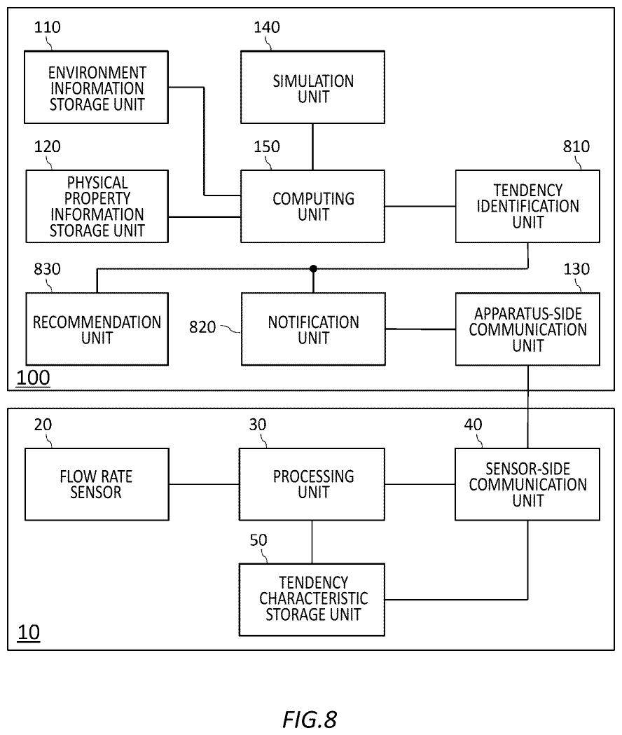

FIG. 8 illustrates an example of a block diagram of the virtual flow rate computing apparatus 100 according to a second modification together with the sensor module 10. In the above-described embodiment, a case where the virtual flow rate computing apparatus 100 diagnoses the flow rate sensor 20 on the basis of the virtual flow rate has been described as an example. However, in the present modification, the virtual flow rate computing apparatus 100 identifies the variation tendency of the virtual flow rate.

The virtual flow rate computing apparatus 100 according to the present modification further includes a tendency identification unit 810, a notification unit 820, and a recommendation unit 830.

For example, the computing unit 150 may compute each virtual flow rate in a case where at least one variable of the environment information or the physical property information is varied. As an example, the computing unit 150 may compute each virtual flow rate in a case where the fluid temperature is varied in a range of +10° C. The computing unit 150 may supply the virtual flow rates computed under different conditions in this manner to the tendency identification unit 810 together with the conditions when the virtual flow rates are computed.

On the basis of the information supplied from the computing unit 150, the tendency identification unit 810 can obtain a tendency between the variable (for example, the fluid temperature) having been varied and the virtual flow rate. For example, in this manner, the tendency identification unit 810 can identify the tendency of the virtual flow rate in a case where at least one variable of the environment information or the physical property information is varied.

Here, in the environment information or the physical property information, there are a variable which is insensitive to the virtual flow rate and a variable which has a certain tendency (for example, a monotonic increase, a monotonic decrease, a tendency due to a function, or the like). When the variable having a certain tendency is found, the tendency identification unit 810 may supply information regarding the tendency to the notification unit 820. At this time, for example, the tendency identification unit 810 may derive a plurality of curves obtained by approximating (for example, linear approximation, exponential approximation, logarithmic approximation, polynomial approximation, power approximation, or the like) the data of the scatter diagram of the variable and the virtual flow rate to various types, and select, as an approximate curve, a curve in which the square (the closer to 1, the stronger the correlation, and the closer to 0, the weaker the correlation) of a correlation coefficient between the data of the scatter diagram and each curve is largest. In addition, the tendency identification unit 810 may form the selected approximate curve into a mathematical expression and calculate a correction function from the mathematical expression. For example, the tendency identification unit 810 may supply, as the information regarding the tendency, information indicating such an approximate curve or correction function to the notification unit 820.

Then, the notification unit 820 may notify the sensor module 10 of the information regarding the tendency via the apparatus-side communication unit 130. For example, in this manner, the notification unit 820 can notify the sensor module 10 including the flow rate sensor 20 of the information regarding the tendency.

Therefore, in the present modification, the sensor module 10 may further include a tendency characteristic storage unit 50. The tendency characteristic storage unit 50 may store, as tendency characteristics, the information regarding the tendency notified from the virtual flow rate computing apparatus 100. Then, the processing unit 30 may perform signal processing on the output signal from the sensor on the basis of the tendency characteristics stored in the tendency characteristic storage unit 50. As an example, the processing unit 30 may perform correction processing on the output signal from the sensor by using the correction function stored in the tendency characteristic storage unit 50.

When there is a plurality of flow rate sensors 20 for which the virtual flow rate is to be computed, the tendency identification unit 810 can also identify, for each flow rate sensor 20, the tendency of the virtual flow rate in a case where at least one variable is varied. Note that the plurality of flow rate sensors 20 may be different from each other in at least one of the supplier and the sensing principle. In such a case, the tendency identification unit 810 may supply, to the recommendation unit 830, the information regarding each tendency identified for each flow rate sensor 20.

Then, the recommendation unit 830 may decide the flow rate sensor 20 to be recommended from among the plurality of flow rate sensors 20 on the basis of the tendency of each flow rate sensor 20. For example, the recommendation unit 830 may compare the magnitude of the variation in the virtual flow rate with respect to one or more selected variables (for example, temperature, viscosity, a Reynolds number, or the like) among the plurality of flow rate sensors 20, and decide, as the recommended flow rate sensor 20, the flow rate sensor 20 having the smallest variation. For example, in this manner, the virtual flow rate computing apparatus 100 according to the present modification can compare the variation characteristics of the plurality of flow rate sensors 20 of various types by various suppliers, and can recommend, to the user, the flow rate sensor 20 optimal for the use environment.

Various embodiments of the present invention may be described with reference to flowcharts and block diagrams whose blocks may represent (1) stages of processes in which operations are performed or (2) sections of apparatuses responsible for performing operations. Certain stages and sections may be implemented by dedicated circuit, programmable circuit supplied with computer readable instructions stored on computer readable media, and/or processors supplied with computer readable instructions stored on computer readable media. Dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical operations, a memory element such as a flip-flop, a register, a field programmable gate array (FPGA) and a programmable logic array (PLA), and the like.

A computer readable medium may include any tangible device that can store instructions to be executed by a suitable device, and as a result, the computer readable medium having instructions stored thereon includes an article of manufacture including instructions which can be executed in order to create means for performing operations designated in the flowcharts or block diagrams. Examples of the computer readable medium may include an electronic storage medium, a magnetic storage medium, an optical storage medium, an electromagnetic storage medium, a semiconductor storage medium, and the like. More specific examples of the computer-readable medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-ray (registered trademark) disk, a memory stick, an integrated circuit card, and the like.

The computer-readable instruction may include: an assembler instruction, an instruction-set-architecture (ISA) instruction; a machine instruction; a machine dependent instruction; a microcode; a firmware instruction; state-setting data; or either a source code or an object code written in any combination of one or more programming languages, including an object oriented programming language such as Smalltalk (registered trademark), JAVA (registered trademark), C++, or the like; and a conventional procedural programming language such as a “C” programming language or a similar programming language.

Computer-readable instructions may be provided to a processor of a general-purpose computer, special purpose computer, or other programmable data processing apparatuses, or to programmable circuitry, locally or via a local area network (LAN), wide area network (WAN) such as the Internet, or the like, to execute the computer-readable instructions to create means for performing operations specified in the flowcharts or block diagrams. Examples of the processor include a computer processor, a processing unit, a microprocessor, a digital signal processor, a controller, a microcontroller, and the like.

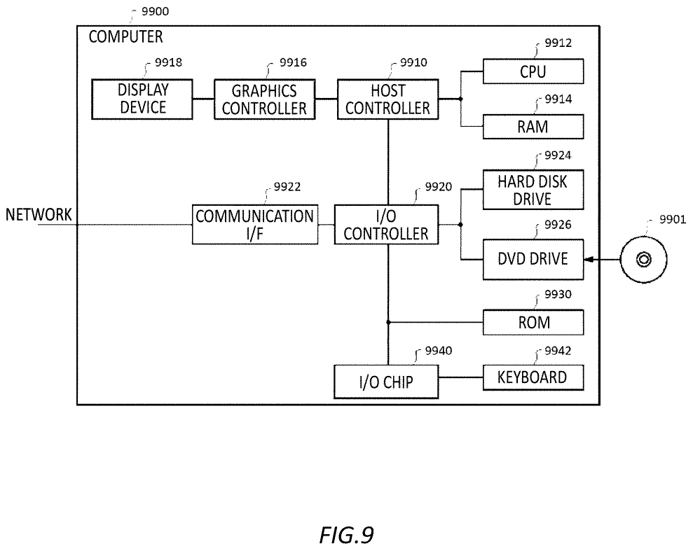

FIG. 9 illustrates an example of a computer 9900 in which a plurality of aspects of the present invention may be embodied in whole or in part. A program that is installed in the computer 9900 can cause the computer 9900 to function as or execute operations associated with the apparatus of the embodiment of the present invention or one or more sections of the apparatus, and/or cause the computer 9900 to execute the processes of the embodiment of the present invention or steps thereof. Such a program may be executed by a CPU 9912 so as to cause the computer 9900 to execute certain operations associated with some or all of the flowcharts and the blocks in the block diagrams described herein.

The computer 9900 according to the present embodiment includes the CPU 9912, a RAM 9914, a graphics controller 9916 and a display device 9918, which are mutually connected by a host controller 9910. The computer 9900 further includes input/output units such as a communication interface 9922, a hard disk drive 9924, a DVD drive 9926 and an IC card drive, which are connected to the host controller 9910 via an input/output controller 9920. The computer also includes legacy input/output units such as a ROM 9930 and a keyboard 9942, which are connected to the input/output controller 9920 via an input/output chip 9940.

The CPU 9912 operates according to programs stored in the ROM 9930 and the RAM 9914, thereby controlling each unit. The graphics controller 9916 acquires image data generated by the CPU 9912 on a frame buffer or the like provided in the RAM 9914 or in itself, and causes the image data to be displayed on the display device 9918.

The communication interface 9922 communicates with other electronic devices via a network. The hard disk drive 9924 stores programs and data that are used by the CPU 9912 within the computer 9900. The DVD drive 9926 reads programs or data from a DVD-ROM 9901, and provides the hard disk drive 9924 with the programs or data via the RAM 9914. The IC card drive reads the programs and the data from the IC card, and/or writes the programs and the data to the IC card.

The ROM 9930 stores therein a boot program or the like executed by the computer 9900 at the time of activation, and/or a program depending on the hardware of the computer 9900. The input/output chip 9940 may also connect various input/output units via a parallel port, a serial port, a keyboard port, a mouse port or the like to the input/output controller 9920.

A program is provided by a computer-readable medium such as the DVD-ROM 9901 or the IC card. The program is read from the computer-readable medium, installed into the hard disk drive 9924, RAM 9914, or ROM 9930, which are also examples of a computer-readable medium, and executed by CPU 9912. The information processing described in these programs is read into the computer 9900, resulting in cooperation between a program and the above-mentioned various types of hardware resources. An apparatus or method may be constituted by realizing the operation or processing of information in accordance with the usage of the computer 9900.

For example, when communication is performed between the computer 9900 and an external device, the CPU 9912 may execute a communication program loaded onto the RAM 9914 to instruct communication processing to the communication interface 9922, based on the processing described in the communication program. The communication interface 9922, under control of the CPU 9912, reads transmission data stored on a transmission buffer region provided in a recording medium such as the RAM 9914, the hard disk drive 9924, DVD-ROM 9901, or the IC card, and transmits the read transmission data to a network or writes reception data received from a network to a reception buffer region or the like provided on the recording medium.

Also the CPU 9912 may cause all or a necessary portion of a file or a database to be read into the RAM 9914, wherein the file or the database has been stored in an external recording medium such as the hard disk drive 9924, the DVD drive 9926 (DVD-ROM 9901), the IC card, etc., and perform various types of processing on the data on the RAM 9914. The CPU 9912 then writes back the processed data to the external recording medium.

Various types of information such as various types of programs, data, tables, and databases may be stored in a recording medium and subjected to information processing. The CPU 9912 may perform various types of processing on the data read from the RAM 9914, which includes various types of operations, information processing, condition judging, conditional branch, unconditional branch, search/replacement of information, etc., as described throughout this disclosure and designated by an instruction sequence of programs, and writes the result back to the RAM 9914. Also the CPU 9912 may search for information in a file, a database, etc., in the recording medium. For example, when a plurality of entries, each having an attribute value of a first attribute associated with an attribute value of a second attribute, are stored in the recording medium, the CPU 9912 may search for an entry matching the condition whose attribute value of the first attribute is designated, from among the plurality of entries, and read the attribute value of the second attribute stored in the entry, thereby acquiring the attribute value of the second attribute associated with the first attribute satisfying the predetermined condition.

The above-described program or software modules may be stored in the computer-readable medium on or near the computer 9900. Also a recording medium such as a hard disk or a RAM provided in a server system connected to a dedicated communication network or the Internet can be used as the computer-readable medium, thereby providing the program to the computer 9900 via the network.

While the present invention has been described by way of the embodiments, the technical scope of the present invention is not limited to the above-described embodiments. It is apparent to persons skilled in the art that various alterations or improvements can be made to the above-described embodiments. It is also apparent from the description of the claims that embodiments added with such alterations or improvements can be included in the technical scope of the present invention.

Note that the operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the operation flow is described by using phrases such as “first” or “next” in the scope of the claims, specification, or drawings, it does not necessarily mean that the process must be performed in this order.

### REFERENCE SIGNS LIST

10: sensor module;
20: flow rate sensor;
30: processing unit;
40: sensor-side communication unit;
50: tendency characteristic storage unit;
100: virtual flow rate computing apparatus;
110: environment information storage unit;
120: physical property information storage unit;
130: apparatus-side communication unit;
140: simulation unit;
141: fluid simulation unit;
142: stress simulation unit;
143: electromagnetic field simulation unit;
144: ultrasonic propagation simulation unit;
150: computing unit;
160: diagnosis unit;
710: simulation result storage unit;
810: tendency identification unit;
820: notification unit;
830: recommendation unit;
9900: computer;
9901: DVD-ROM;
9910: host controller;
9912: CPU;
9914: RAM;
9916: graphics controller;
9918: display device;
9920: input/output controller;
9922: communication interface;
9924: hard disk drive;
9926: DVD drive;
9930: ROM;
9940: input/output chip; and
9942: keyboard.

1. A virtual flow rate computing apparatus comprising:
an environment information storage unit which stores environment information indicating environment of a real space in which a flow rate sensor is instrumented;
a physical property information storage unit which stores physical property information indicating physical properties of fluid to be measured;
a simulation unit which executes a simulation related to measurement of the fluid in a virtual space, which reproduces the real space, by using the environment information and the physical property information; and
a computing unit which computes a virtual flow rate, which is an estimate of an actual flow rate to be actually measured by the flow rate sensor, on a basis of a result of the simulation.

2. The virtual flow rate computing apparatus according to claim 1, further comprising a diagnosis unit which diagnoses the flow rate sensor on a basis of the actual flow rate and the virtual flow rate.

3. The virtual flow rate computing apparatus according to claim 2, wherein the diagnosis unit issues an alert when a difference between the actual flow rate and the virtual flow rate does not satisfy a predetermined criterion.

4. The virtual flow rate computing apparatus according to claim 1, wherein the computing unit decides processing for computing the virtual flow rate, on a basis of the actual flow rate and the virtual flow rate in a period in which an operation of the flow rate sensor is regarded as normal.

5. The virtual flow rate computing apparatus according to claim 1, further comprising a simulation result storage unit which stores a result of the simulation, wherein
the computing unit reuses at least a part of the stored result.

6. The virtual flow rate computing apparatus according to claim 1, further comprising a tendency identification unit which identifies a tendency of the virtual flow rate in a case where at least one variable of the environment information or the physical property information is varied.

7. The virtual flow rate computing apparatus according to claim 6, further comprising a notification unit which notifies a sensor module including the flow rate sensor of information regarding the tendency.

8. The virtual flow rate computing apparatus according to claim 6, further comprising a recommendation unit which decides the flow rate sensor to be recommended from among a plurality of flow rate sensors, on a basis of the tendency for each of the flow rate sensors.

9. The virtual flow rate computing apparatus according to claim 1, wherein the simulation unit simulates at least one of stress, fluid, an electromagnetic field, or an ultrasonic wave in the virtual space.

10. The virtual flow rate computing apparatus according to claim 1, wherein the flow rate sensor is at least one of a Coriolis flow meter, an ultrasonic flow meter, an electromagnetic flow meter, or a vortex flow meter.

11. The virtual flow rate computing apparatus according to claim 1, wherein the virtual flow rate computing apparatus is provided by a cloud server.

12. A virtual flow rate computing method performed by a computer, comprising:
storing environment information indicating environment of a real space in which a flow rate sensor is instrumented;
storing physical property information indicating physical properties of fluid to be measured;
executing a simulation related to measurement of the fluid in a virtual space, which reproduces the real space, by using the environment information and the physical property information; and
computing a virtual flow rate, which is an estimate of an actual flow rate to be actually measured by the flow rate sensor, on a basis of a result of the simulation.

13. A non-transitory computer readable medium having recorded thereon a virtual flow rate computing program that, when executed by a computer, causes the computer to function as:
an environment information storage unit which stores environment information indicating environment of a real space in which a flow rate sensor is instrumented;
a physical property information storage unit which stores physical property information indicating physical properties of fluid to be measured;
a simulation unit which executes a simulation related to measurement of the fluid in a virtual space, which reproduces the real space, by using the environment information and the physical property information; and
a computing unit which computes a virtual flow rate, which is an estimate of an actual flow rate to be actually measured by the flow rate sensor, on a basis of a result of the simulation.

14. The virtual flow rate computing apparatus according to claim 2, wherein the simulation unit simulates at least one of stress, fluid, an electromagnetic field, or an ultrasonic wave in the virtual space.

15. The virtual flow rate computing apparatus according to claim 2, wherein the flow rate sensor is at least one of a Coriolis flow meter, an ultrasonic flow meter, an electromagnetic flow meter, or a vortex flow meter.

16. The virtual flow rate computing apparatus according to claim 2, wherein the virtual flow rate computing apparatus is provided by a cloud server.

17. The virtual flow rate computing apparatus according to claim 4, wherein the simulation unit simulates at least one of stress, fluid, an electromagnetic field, or an ultrasonic wave in the virtual space.

18. The virtual flow rate computing apparatus according to claim 4, wherein the flow rate sensor is at least one of a Coriolis flow meter, an ultrasonic flow meter, an electromagnetic flow meter, or a vortex flow meter.

19. The virtual flow rate computing apparatus according to claim 5, wherein the simulation unit simulates at least one of stress, fluid, an electromagnetic field, or an ultrasonic wave in the virtual space.

20. The virtual flow rate computing apparatus according to claim 5, wherein the flow rate sensor is at least one of a Coriolis flow meter, an ultrasonic flow meter, an electromagnetic flow meter, or a vortex flow meter.
